(19) United States
(12) Patent Application Publication
(10) Pub. No.: US 2026/0240724 A1
(43) Pub. Date: Aug. 20, 2026

(54) EXTENDER FOR A MASSAGE DEVICE WITH A REVERSIBLE HEAD AND NECK

(71) Applicant: Robert Davis, Carlsbad, CA (US)

(72) Inventor: Robert Davis, Carlsbad, CA (US)

(21) Appl. No.: 19/059,006

(22) Filed: Feb. 20, 2025

(51) Int. Cl. A61H 37/00

(52) U.S. Cl. CPC A61H 37/00; A61H 2201/0153; A61H 2201/0192

(57) ABSTRACT

An extender for a massage device handle includes a handle, a cradle assembly configured to receive the massage device handle, and a corner assembly. The cradle assembly includes a cradle frame shaped to receive the massage device handle; a base, wherein the cradle frame is mounted to the base; an adjustable strap having a first end secured to one of a first side of the cradle frame or a first side of the base; and a strap attachment mechanism.

### FIELD

The object of the presently defined device is to allow the user to adjust the massage gun device to the necessary position when administering self-induced massage therapy, allowing for effective massage therapy of the necessary muscle groups.

### BACKGROUND

The majority of massage devices and equipment are designed to apply to another individual rather than oneself. This can be seen by the use of such devices on patients at physical therapy clinics or even physical trainers on their clients. The layout of the device, from the tip to the handle, does not allow an individual to receive the full benefit of the massage device. Of course, the user can apply the massage device to easily accessible areas, such as the frontier leg. However, this does not allow the user to properly apply the massage device to the rest of the body, such as the back and anterior legs. An extender for the massage device could be particularly useful to reach these harder-to-access parts of the body.

### DESCRIPTION OF PRIOR ART

The existing prior art includes many different types of handheld percussion gun devices, none of which were found to include a reversible head. Alternatively, some non-percussion-style massage devices reach around the human body to manually massage the back. These percussion and non-percussion devices on their own do not disclose the presently presented invention. The invention here allows the self-administration of a percussion massage device. The other devices either require someone else to administer the device to you or do not adequately reach and release the tensioned areas necessary for a user.

Even current massage gun extenders do not have the capability to reverse the head of the device as the presently presented invention does. These rigid massage gun extenders may allow the user to reach other areas of the body, such as the back, but they do not do so adequately. The position of the massage gun cannot be changed, and the force applied to the area is limited due to the rigid structure of these current massage gun holders. To properly relieve tension in a muscle, the massage gun must be applied at the proper angle and with the proper amount of pressure. These two tasks are not able to be completed with current massage gun extenders. Even the most maneuverable of massage gun extenders are bulky and awkward when attempting to reach areas beyond the mid-back. An example of this is attempting to use current massage gun extenders properly on the lower back, glutes, and hamstrings.

A person having ordinary skill in the art is any user who senses tension in any of the various muscle groups and then wishes to apply massage therapy via a percussion massage gun device. This person in the clinical setting could be a physical therapist or masseuse. In a non-clinical environment, family members or friends often apply the massage gun to the afflicted area. However, with self-induced therapy, the person having ordinary skill in the art would be anyone wanting to administer the massage gun to themselves.

The present extender enables the user to apply massage therapy through various massage devices on all areas themselves with little effort or strain. The reversible head of this device allows the user to reach all areas of their body in a relaxed position, which is critical to releasing tensed muscle groups. The reversible head also allows the selected massage gun to have the head of the device at the most effective angle for muscle tension release. The present extender with the reversible head is not limited to a particular massage device (e.g. percussion massage gun); it is compatible with virtually any device on the market. The reversible head as well would allow for the use of any future, larger massage devices that may be released. Prior art exists, such as patent application Ser. No. 17/383,099. This discloses a generic massage gun holder. This device has an extendable handle and a cradle to hold a massage device. Other massage gun extenders similar to this are on the market. However, these devices lack the main purpose of this massage gun holder: a reversible neck. These devices do extend the handle of a massage device, but they cannot properly apply a massage gun device to the tensed muscle groups as they lack the reversible neck and head of the invention disclosed here. This device can apply massage therapy to all areas of the body in a relaxed state and with the massage device at the proper angle. All three of these tasks are not achievable by current products on the market. The reversible neck allows the massage device in use to be positioned as necessary in relation to the body. This ability to flip the direction of the massage device via the reversible neck allows flexibility of self-massage therapy that is not possible with the prior art. More flexibility and customization of the device are achieved via the reversible head, which can invert the position of the massage gun device. This combination with the main reversible neck unit allows optimal self-induced massage therapy.

### SUMMARY

The presently disclosed device is a massage device extender with a reversible neck. The handles of the massage devices will attach to a telescoping arm, curved neck and reversible head. This extender, in general, relieves the issue of needing another individual to apply the massage gun to the necessary portion of the body. The reversible head of the extender for a massage device allows more types of massage devices to be equipped and allows for better positioning of the massage gun head. The reversible head, curved neck, and telescoping arm also allow the extender to reach all portions of the body properly. Without this type of extender, the user would have to attempt to reach around and apply the device ineffectively or use a less effective method of massaging the area, such as a foam roller.

The presently defined extender for a massage device provides the user with the ability to apply self-induced massage therapy by extending the handle of the massage device and properly positioning the massage device with the curved neck to the needed position. Further flexibility of the device is achievable by inverting the head of the device in combination with the curved neck. The user can attach the desired percussive massage gun device to the head. The user can then adjust the length of the device and the position of the neck to acquire the desired position of the device. The user can apply self-induced massage therapy to the desired area from here. The device allows the user to reach all portions of the body while in a relaxed state. As well, the reversibility of the neck ensures that the massage therapy is applied at the correct angle with the necessary amount of pressure. The device is equipped with handles to allow the proper movement of the device around the body and ensure the user is in a relaxed position.

### BRIEF DESCRIPTION OF DRAWINGS

In the following detailed portion of the present description, the teachings of the present application will be explained in more detail with reference to the example embodiments shown in the drawings, in which:

FIG. 1A is a perspective view from the left of an extender of a massage device handle according to the present application, including a cradle assembly provided in a first position.

FIG. 1B is a perspective view from the right of the extender of FIG. 1A.

FIG. 2A is a perspective view from the left of the extender of FIG. 1A with the cradle assembly provided in a second position.

FIG. 2B is a perspective view from the right of the extender of FIG. 1A with the cradle assembly in the second position.

FIG. 3 is a perspective view of the cradle assembly of the extender of FIG. 1A.

FIG. 4 is an exploded view of the cradle assembly of FIG. 3.

FIG. 5A is a sectional view of the cradle assembly taken along the lines 5A-5A in FIG. 1A.

FIG. 5B is a sectional view of the cradle assembly and the corner assembly taken along lines 5B-5B of FIG. 1B.

FIG. 6 is a perspective view of a corner assembly of the extender of FIG. 1.

FIG. 7 is a perspective view of a handle of the extender of FIG. 1.

FIG. 8 is a perspective view of a supplemental handle of the extender of FIG. 1.

FIG. 9 is a perspective view of the extender with the cradle assembly provided in a first position of FIG. 1A, including a massage device handle positioned within the extender.

FIG. 10 is a perspective view of the extender with the cradle assembly provided in a second position of FIG. 2A, including a massage device handle positioned within the extender.

### DETAILED DESCRIPTION OF DRAWINGS

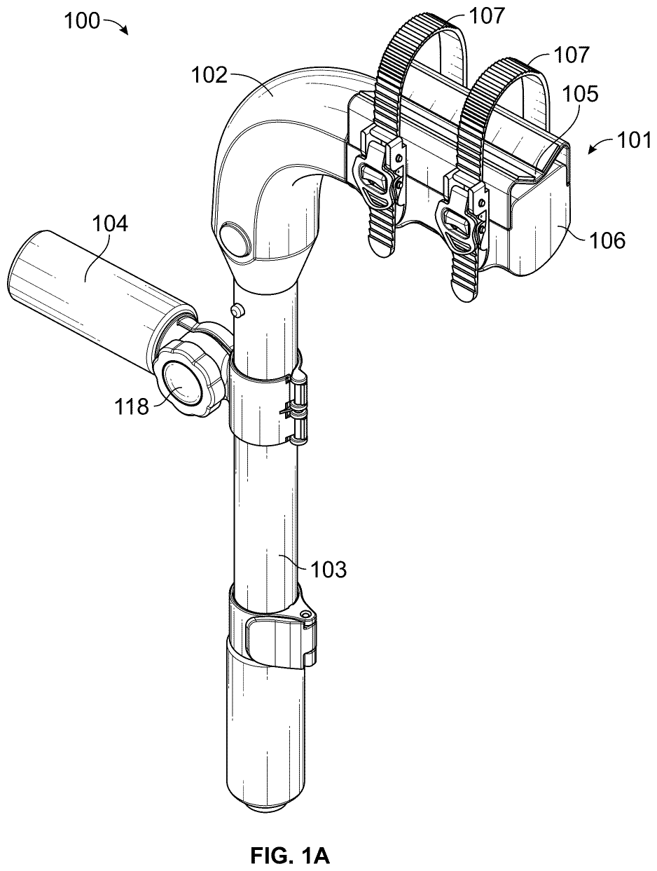

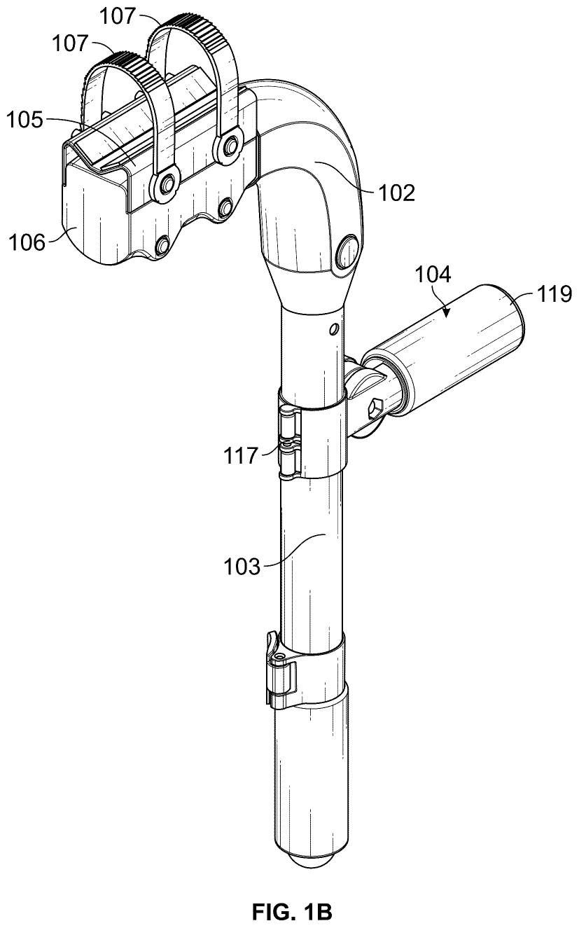

FIGS. 1-8 illustrate an example embodiment of a massage device extender 100 for use with a massage device. Specifically, the extender 100 is configured to receive a massage device handle so that a user can apply the massage device to portions of the user's body that are difficult to reach. For example, using the massage device extender 100, a user can apply a massage gun throughout the user's back and shoulders.

In the illustrated embodiments, the extender 100 includes a cradle assembly 101, a corner assembly 102, a handle 103, and an optional supplemental handle 104. The handle of the massage device is inserted into the cradle assembly 101 as described below. The user grasps the handle and the supplemental handle to apply the massage device to the body, and the corner assembly 102 connects the cradle assembly 101 to the handle 103.

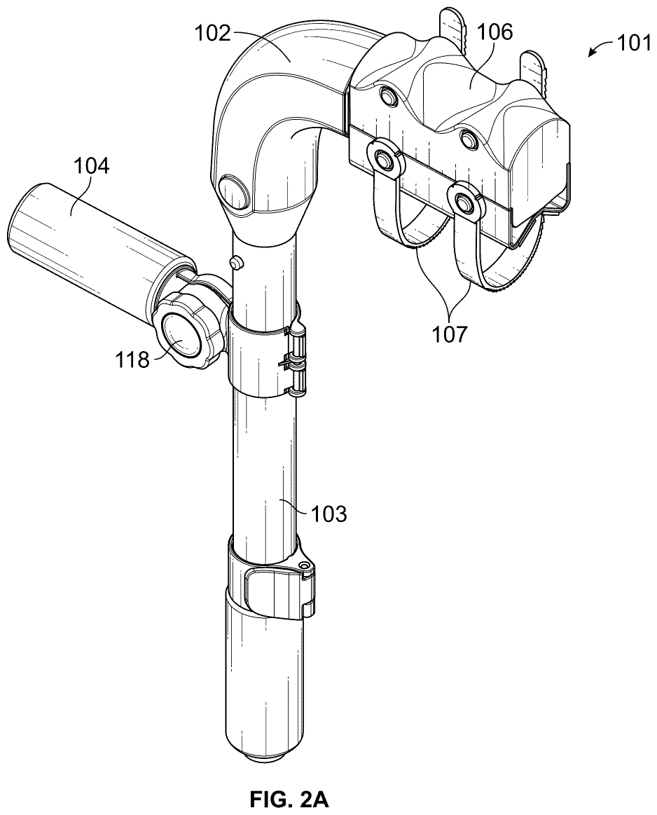

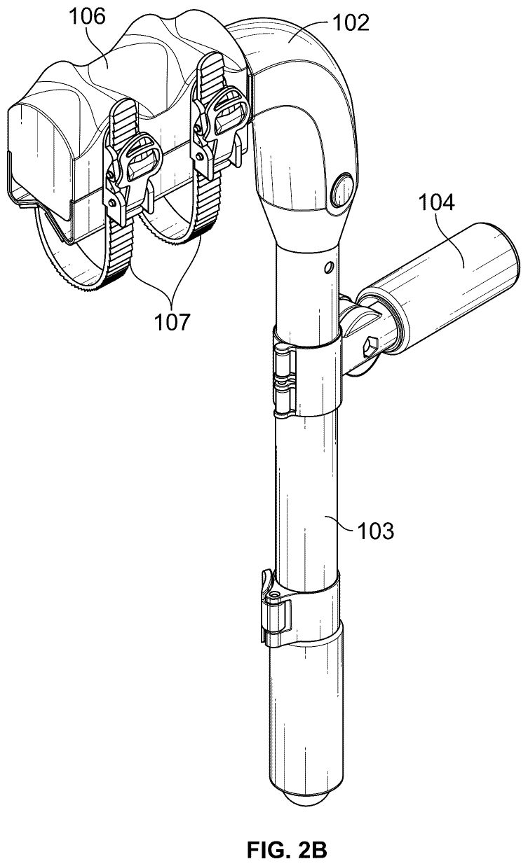

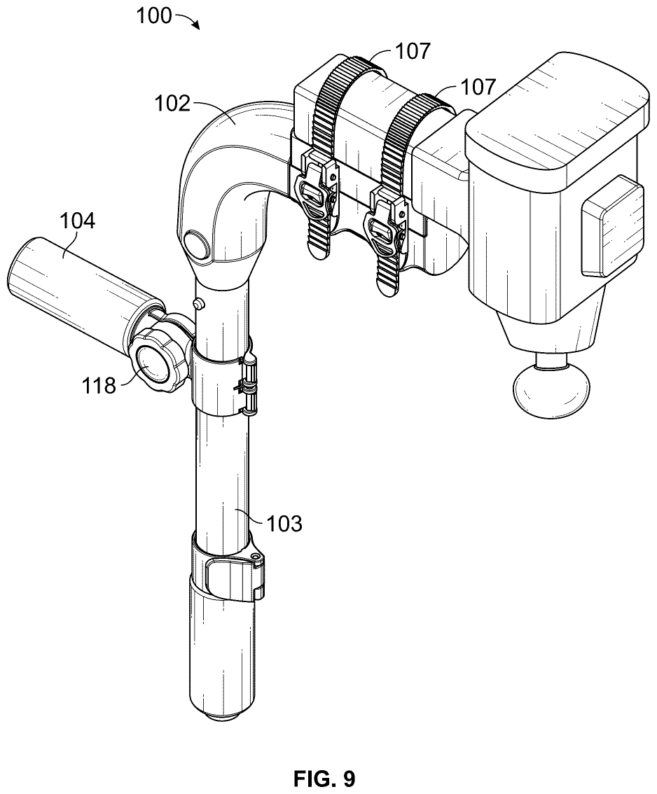

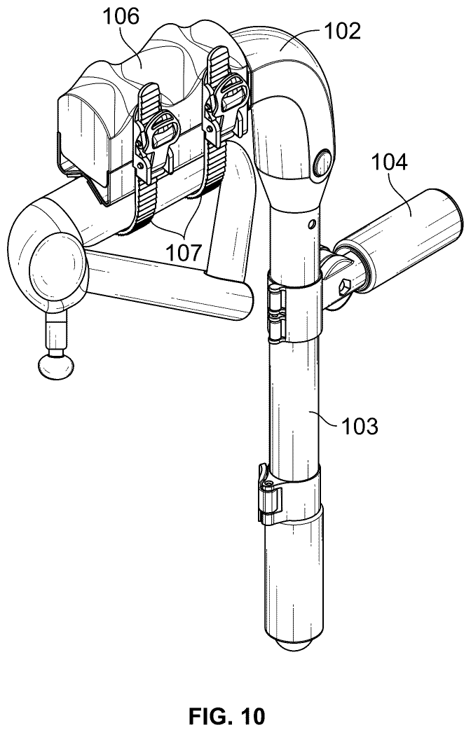

During use, the cradle assembly 101 is secured on the corner assembly 102 in either a first position (FIGS. 1A, 1B, and 9) or a second position (FIGS. 2A, 2B, and 10). The different positions of the cradle assembly 101 on the extender 100 provide additional options to the user when attempting to reach areas of the body that are difficult to access. This variability enables the cradle assembly 101 to accommodate all types of massage guns, including triangular, circular, and straight designs. Whereas conventional massage extenders have a fixed holder that can only fit one type of massage gun, the extender 100 of the present application offers versatility and adaptability. By allowing the cradle assembly 101 to be positioned in multiple orientations, the extender 100 ensures that users can securely mount and use any massage gun shape without limitation. FIGS. 9 and 10 illustrate different types of massage devices that may be positioned within the extender 100, depending on the position of the cradle assembly 101 in either the first position or the second position.

Still further, as described in greater detail below, the extender 100 includes a number of aspects that allow for modification and adjustability. The user can modify the length of the handle 103, adjust the location and orientation of the supplemental handle 104 along the handle 103, and adjust the cradle assembly 101 in one of two positions on the corner assembly 102 to configure the positioning of the massage device. These modifications enable the user to apply the massage device to various parts of the body while minimizing stress and discomfort when doing so.

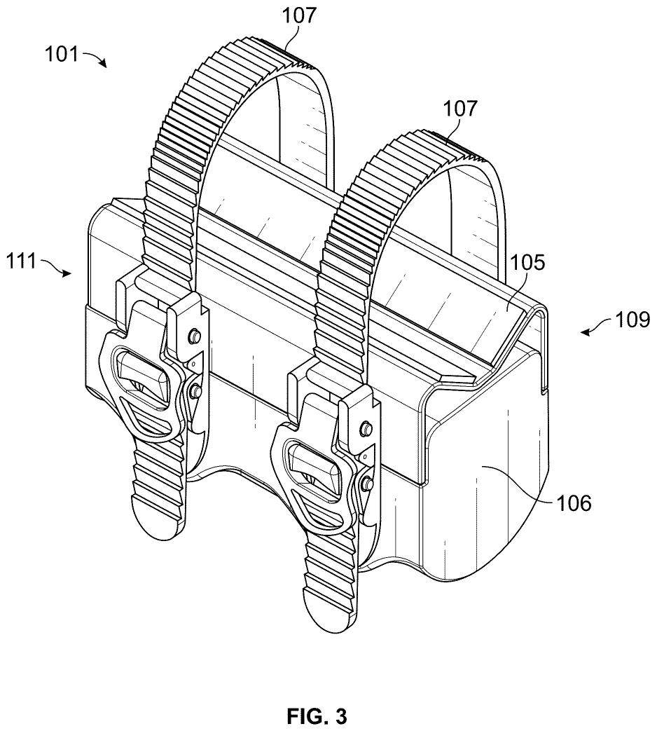

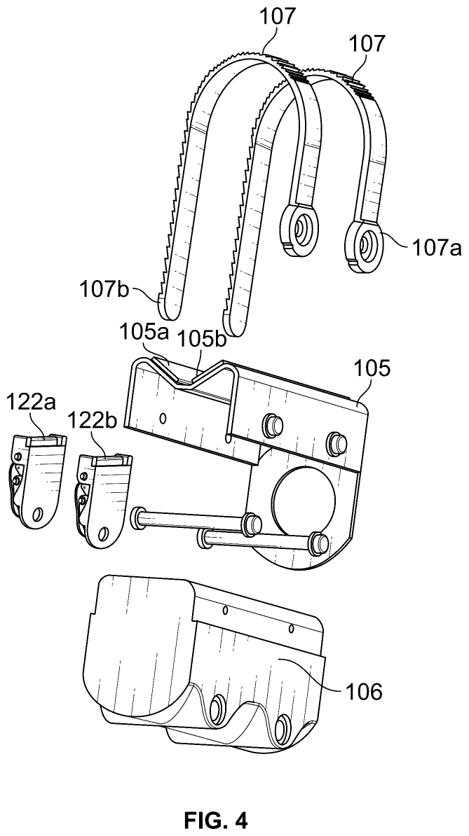

Referring to FIGS. 3 and 4, the cradle assembly 101 includes a cradle frame 105 mounted on a base 106. Adjustable straps 107 extend from a first side 109 of the cradle frame 105 and/or the base 106 to a second side 111 of the cradle frame 105 and/or the base 106. The massage gun handle is held in place within the cradle frame 105 via the adjustable straps 107. The cradle frame 105 is constructed with an M-shape in cross section to securely retain a massage gun within the cradle assembly 101, providing structural support and stability during operation. The cradle frame 105 may also incorporate stepped sections, which are fastened with multiple screws to enhance stability and minimize operational vibrations.

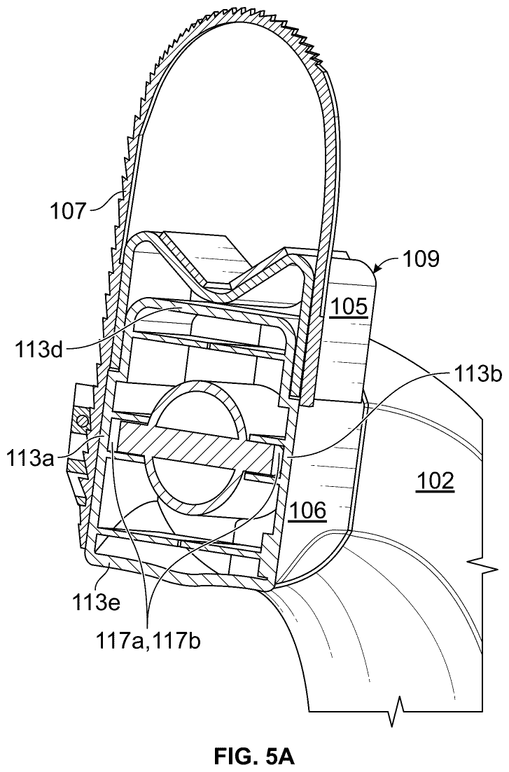

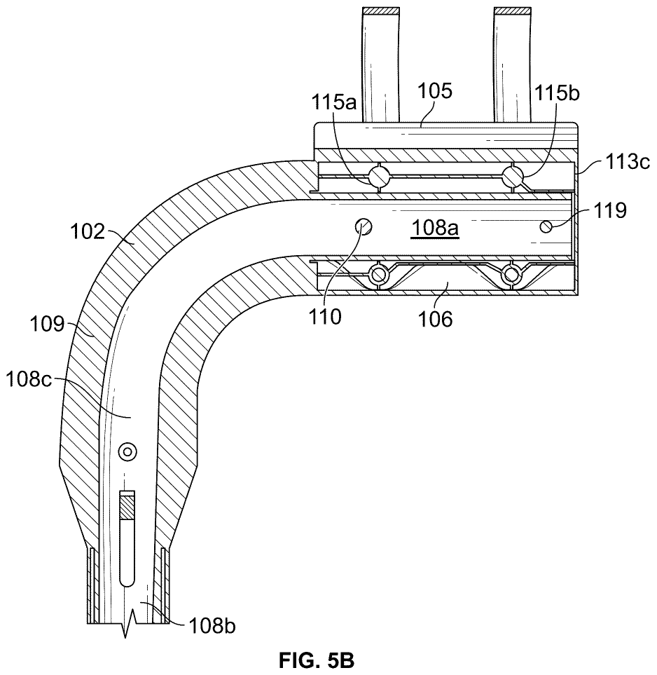

Seen best in FIGS. 5A and 5B, the base 106 includes a housing 113 with internal structures that facilitate secure attachment. The housing 113 in generally hollow with an elongated, rectangular shape, including first and second opposing sidewalls 113a, 113b, an outer endwall 113c, an upper surface 113d, and a bottom surface 113e. Reinforced sidewalls contribute to the overall rigidity of the cradle assembly 101. Referring to FIG. 5B, within the housing, a pair of internal planar members 115a, 115b parallel to the outer endwall 113c include round openings to receive the corner assembly 102 as described in greater detail below. Referring to FIG. 5A, along internal surfaces of first and second sidewalls 113a, 113b, internal channels 117a, 117b are provided along the length thereof for engaging with the corner assembly 102 as described below. Near the outer endwall 113c, first and second spring-loaded balls 119, 119 project internally from respective first and second cylinder housings and are configured to engage with detent openings on the corner assembly 102, as described below. Further, fasteners firmly affix the cradle frame 105 to the base 106 as shown in FIG. 4.

The cradle assembly 101 uses an adjustable strap 107 to securely hold the massage device. A first end 107a of the strap 107 anchors to either the first side of the cradle frame 105 or the base 106, while a second end 107b attaches to a fastening mechanism 122 on the second side of the cradle frame 105 or base 106. In some embodiments, the strap 107 includes a stepped surface, enabling precise tension adjustments within the fastening mechanism 122. The fastening mechanism 122 incorporates a locking buckle with a lever system that automatically engages when the strap is inserted, preventing unintended loosening. This buckle assembly includes a platform that secures the buckle to the base 106, a locking lever with engagement and secondary release sections, a clamping mechanism that maintains strap tension, a manual release mechanism, and a biasing element that keeps the locking lever engaged for added stability. The biasing element, a spring, applies consistent pressure to the locking lever, ensuring it remains engaged for added stability and preventing accidental loosening. The adjustable strap 107 may consist of a plastic material to accommodate different massage device handle sizes. In other embodiments, the fastening system may include buckles, hook-and-loop closures, or snap-fit connectors.

The cradle frame 105 of the cradle assembly 101 may feature an elongated M-shaped structure, with two inner elongated surfaces 105a, 105b that angle toward one another and toward the base 106. These surfaces 105a, 105b are designed to improve grip and provide support for the massage device handle. This configuration enhances the retention of the device while simultaneously reducing vibration during operation.

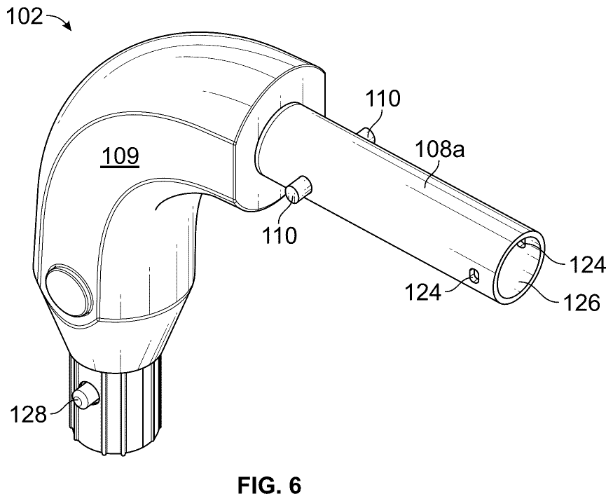

The corner assembly 102, shown in FIG. 6, provides a link between the cradle assembly 101 and the handle 103. The corner assembly 102 includes a tube including a cradle tube end 108a and a handle tube end 108b, and the tube includes an angled portion 108c therebetween. A corner housing 109 extends between the cradle tube end 108a and the handle tube end 108b.

Referring to FIG. 6, the cradle tube end 108a includes first and second protrusions 110 that are received by the first and second internal channels 117a, 177b of the base housing 106 of the cradle assembly 101. Opposing openings 124 near an outer end 126 of the cradle tube end 108a receive the spring-loaded balls 119 provided within the first and second internal channels 117a, 117b of the base housing 106 when the cradle tube end 108a is fully inserted into the base housing 106 of the cradle assembly 101, securing the cradle assembly 1010 in place on the cradle tube end 108a.

The cradle assembly 101 may be positioned on the cradle tube end 108a in two configurations. The first position as shown in FIGS. 1A and 1B provides for the base 106 to attach to the cradle tube end 108a with the cradle frame 105 and the adjustable straps 107 directed away from the handle 103. The second position shown in FIGS. 2A and 2B provides for the base 106 to be attached to the cradle tube end 108a with the cradle frame 105 and the adjustable straps 107 directed toward the handle 103.

In both of the first and second positions, the projections 110 of the cradle tube end 108a slot into the first and second internal channels 117a, 177b within the base 106, and the spring-loaded balls 119 within the channels 117a, 177b near the outer end 113c of the base housing 106 are received by the openings 124 within the cradle tube end 108, ensuring a secure connection.

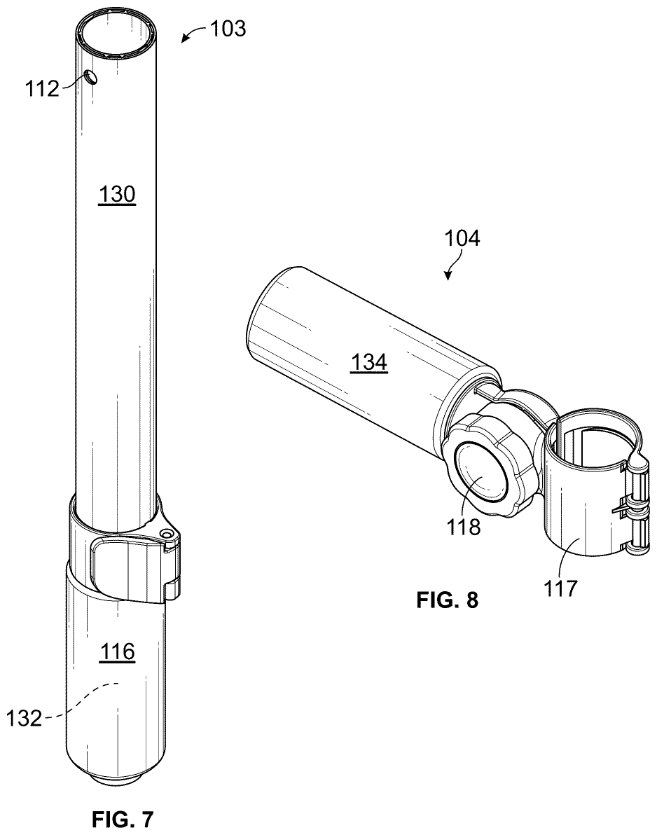

Referring to FIGS. 6 and 7, on the handle tube end 108b, the tube 108b includes a pair of opposing spring-loaded lugs 128 that are received by corresponding openings 112 in the handle 103, allowing for a secure yet adjustable connection.

The handle 103, shown in FIG. 7, includes a main tubing section 130 and a telescoping arm 132. The main tubing section 130 receives the telescoping arm 132 and a friction locking mechanism 134 maintains the telescoping arm 132 in position relative to the main tubing section 130, to allow for the length of the handle 103 to be adjustable. This functionality allows users to customize the extender length to suit their reach requirements. At the distal end 115 of the handle 103, a textured gripping surface 116 provides a secure and ergonomic grip.

In some embodiments, a supplemental handle 104 of FIG. 8 is also attached to the primary handle 103, as shown in FIG. 1, offering users more control over manipulation of the extender device 100 during use. For example, the user can position the supplemental handle 104 at a location on the handle 103 near the corner assembly 102, position the massage device and extender 100 such that the massage device is applying pressure to the user's back, rotate the supplemental handle 104 parallel to the user's chest and towards the user's shoulder such that the user can use his upper arm, between the shoulder and the elbow, to pull the extender 100 away from the body and apply pressure with the massage device to the back.

In the illustrated embodiment, the supplemental handle 104 includes an attachment tube 117, a tightening wheel 118, and a distal end 119. The attachment tube 117 receives the main tubing section 130 of the handle 103, and the tightening wheel 118 moves between a loosened position and a tightened position. In the loosened position, the halves of the attachment tube 117 are released and movable about a hinge in order to enclose the halves in the desired position along the main tubing section 130. Once the attachment tube 117 is located in the desired position, the wheel 118 is tightened, which causes the halves of the attachment tube 117 to tighten about the main tubing section. The wheel 118 includes a first portion attached to a first half of the attachment tube 117. The wheel also includes a second portion attached to a second half of the attachment tube 117, and the wheel is threaded through the second portion and received by the first portion. The distal end of the supplemental handle also includes an ergonomic grip 134, which improves comfort and reduces hand fatigue during extended use.

The overall design of the extender ensures that the cradle assembly 101 securely holds an object while allowing user-configurable positioning for optimal usability.

What is claimed is:

1. An extender for a massage device handle, the extender comprising:
a handle;
a cradle assembly configured to receive the massage device handle, the cradle assembly including:
a cradle frame shaped to receive the massage device handle;
a base, wherein the cradle frame is mounted to the base;
an adjustable strap having a first end secured to one of a first side of the cradle frame or a first side of the base;
a strap attachment mechanism configured to receive a second end of the adjustable strap, the strap buckle mechanism secured to one of a second side of the cradle frame or a second side of the base opposite to the one of the first side of the cradle frame or the first side of the base; and
a corner assembly connecting the handle and the cradle assembly, wherein the cradle assembly is configured to move between a first position and a second position relative to the corner assembly.

2. The extender of claim 1, wherein the corner assembly includes a cradle attachment tube for receiving the base of the cradle assembly,
wherein the base includes a housing defining a cavity, the housing having first and second internal channels;
wherein the cradle attachment tube includes first and second projections configured to be received by the first and second internal channels, respectively, of the base of the cradle assembly; and
wherein the first and second projections form an interfence fit with the first and second internal channels, respectively, at each of the first and second positions; and
wherein the cradle attachment tube includes two openings at its front, forming a detent mechanism that provides a self-locking feature when the projections engage with the internal channels.

3. The extender of claim 2, wherein the cradle frame is mounted to a surface spanning the first and second side surfaces of the base, wherein the cradle frame of the cradle assembly is directed away from the handle when the cradle assembly is in the first position.

4. The extender of claim 3, wherein the cradle frame is directed toward the handle when the cradle assembly is in the second position.

5. The extender of claim 3, wherein the cradle frame includes textured surface steps securely fastened with multiple screws, the steps providing a enchanced stability.

6. The extender of claim 1, wherein the strap attachment mechanism is selected from the group consisting of buckles, hook-and-loop fasteners, or snap-fit connectors.

7. The extender of claim 1, wherein the adjustable strap includes a stepped surface; wherein the strap attachment mechanism includes at least one buckle with a locking lever, wherein the locking lever is configured to engage the adjustable stepped strap upon insertion, securing the strap in place until manually released.

8. The extender of claim 7, wherein the buckle for the buckle assembly comprising:
a platform securing the buckle to the base of the cradle assembly; a locking lever with a first portion that engages the strap and a second portion operable to release the locking lever;
a strap engagement mechanism comprising a clamping element that holds the strap in place;
a release mechanism that allows for manual releasing of the locking lever to remove the strap; and
a biasing element that maintains the locking lever in a secured position to prevent unintended loosening of the strap.

9. The extender of claim 1, wherein the adjustable strap is made of an elastic material to accommodate various massage device handle sizes.

10. The extender of claim 1 wherein, the handle has an extender system comprising:
a telescoping arm, and
a main tubing section configured to receive the telescoping arm wherein the main tubing section includes a friction locking mechanism to allow for the length of the telescoping arm to be adjusted.

11. The extender of claim 1, wherein the corner assembly includes a handle attachment tube including a detent mechanism, and the telescoping arm includes openings for receiving lugs of the detent mechanism.

12. The extender of claim 11, wherein the cradle frame comprising an elongated member having an M-shape with first and second inner elongated surfaces angled towards one another.

13. The extender of claim 12, wherein each of the first and second inner elongated surfaces includes a padded member.

14. The extender of claim 1, further comprising a supplemental handle including:
an attachment tube configured for receiving the handle; and
a wheel configured to tighten the attachment tube allowing for a friction fit of the attachment tube to the handle.

15. The extender of claim 13, wherein the supplemental handle further comprises an ergonomic grip configured to enchance user comfort and control.

16. The extender for a massage device of claim 1 wherein, the handle and supplemental handles have a gripping surface on the distal end.
